(19) United States
(12) Patent Application Publication
(10) Pub. No.: US 2004/0042551 A1
(43) Pub. Date: Mar. 4, 2004

(54) Motion estimation

(76) Inventors: Tinku Acharya, Chandler, AZ (US); Kalpesh Mehta, Chanler, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/235,121

(22) Filed: Sep. 4, 2002

(51) Int. Cl. H04N 7/12

(52) U.S. Cl. 375/240.16; 375/240.26

(57) ABSTRACT

Embodiments of an image signal processing engine that may be employed for motion estimation calculations is described.

### BACKGROUND

The present disclosure relates to motion estimation and, more particularly, to structures and techniques for computing matching criteria typically employed in motion estimation.

Video coding employing Motion Estimation (ME) and/or Motion Compensation (MC) is widely used in various video coding standards and/or specifications, such as MPEG [see Moving Pictures Experts Group, ISO/IEC/SC29/WG1 1 standard committee]. Advances, for example, in integrated circuit technology, in recent times have made it possible to implement block matching techniques in hardware, such as with silicon or semiconductor devices. An excellent discussion of ME may be found in Bhaskara and Constantis, [see V. Bhaskaran and K. Konstantinides. “Image and Video Compression Standards: Algorithms and Architectures”, Kluwer Academic Publishers, 1995.]

FIG. 1 shows a block diagram of an embodiment of an MPEG type video encoder. For this particular embodiment, a process of block matching involves a reference block and a search window. There are many matching criteria developed in the literature for matching a block of pixels in a video frame (usually the current frame to be encoded) with a block of pixels in the search window in another frame (usually a previous frame). A “reference block” in this context refers to a selected group of pixels from the current frame to be encoded. In MPEG, this is popularly called a macroblock and usually the size of this macroblock is 16×16. A search window in this context refers to a region of pixels from another frame, frequently the previous frame, to be searched to determine the best match. The “Sum-of-Absolute-Difference” (SAD), generally equivalent to the “Mean Absolute Difference” (MAD), is popular amongst a variety of potential matching criteria because of its low computational burden with the ability to omit multiplication or division. Some other examples of matching criteria include Mean Absolute Difference (MAD), Mean Square Error (MSE), Normalized Cross-Correlation Function, Minimized Maximum Error (MiniMax), etc. Of course, any one of a variety of matching criteria may be employed in block matching and, in this context, no particular matching criteria is preferred over any other; although, depending on the particular application, there may be reasons to prefer one over another.

Usually, a search begins with the motion vector, MV=(0,0) or no motion. For this particular embodiment, a search window is the block of pixels from a previous frame around MV=(0,0). The block size and choice of search window size typically reflects an implementation trade-off; therefore, again, no particular size is necessarily preferred over another in this context. For example, the larger the search window, the higher the computational complexity and memory/data bandwidth capability desired, but, likewise, improved is the chance to get a good match. FIG. 1 shows reference block A in the current frame (I) and the best match block B within the search window in the previous frame (P). The displacement (dx, dy) of the matching block B at location/coordinate (x+dx, y+dy) from the reference block A at coordinate (x, y) is called the motion vector and represented as MV=(dx, dy). The technique to compute this MV is popularly referred to as Motion Estimation (ME). There are several motion estimation techniques in the literature [see, for example, V. Bhaskaran and K. Konstantinides. “Image and Video Compression Standards: Algorithms and Architectures”, Kluwer Academic Publishers, 1995.] In this particular embodiment, full-search (FS) Block Matching is employed. However, this approach may be demanding from the viewpoint of raw computational power as well as the appropriate data bandwidth rate desired to support such an approach.

### BRIEF DESCRIPTION OF THE DRAWINGS

The subject matter is particularly pointed out and distinctly claimed in the concluding portion of the specification. The claimed subject matter, however, both as to organization and method of operation, together with objects, features, and advantages thereof, may best be understood by reference to the following detailed description when read with the accompanying drawings in which:

FIG. 1 is a schematic diagram illustrating an embodiment of an MEPG video encoder;

FIG. 2 is a schematic diagram illustrating an embodiment of a two-dimensional mesh coupled architecture employing image signal processors (ISPs);

FIG. 3 is a schematic diagram illustrating an embodiment of an ISP;

FIG. 4 is a schematic diagram illustrating another embodiment of an ISP;

FIG. 5 is a schematic diagram illustrating an embodiment of a technique for pixel data sharing that may be employed in an ISP;

FIG. 6 is a diagram illustrating a pipeline and dataflow for an ISP employing 4 PEs performing parallel calculations;

And FIG. 7 is a schematic diagram of an embodiment of a DDR channel for an ISP, such as the embodiment shown in FIG. 6;

FIG. 8 is a schematic diagram of an embodiment of a layout for a GPR.

### DETAILED DESCRIPTION

In the following detailed description, numerous specific details are set forth in order to provide a thorough understanding of the claimed subject matter. However, it will be understood by those skilled in the art that the claimed subject matter may be practiced without these specific details. In other instances, well-known methods, procedures, components and circuits have not been described in detail in order so as not to obscure the claimed subject matter.

A representative or sample raw performance and/or bandwidth capability to implement a FS method may be calculated. Computing a motion vector, where, for example, the Sum-of-Absolute Difference (SAD) is employed, involves a comparison between a reference block and a corresponding block in a previous frame for respective positions in a search window. Assume that the size of a search window is S×S, resolution of the video is M×N and the frame rate is F frames per second. For a 16×16 macroblock, for example, the number of SAD computations per second involved in full search (FS) motion estimation is

F*(S*S)*(M*N)/(16*16).

As is well-known, the CCIR standard for video employs resolution of 720×480 at 30 frames per second. In MPEG2 and MPEG4 video, the size of a search window for block matching is 32×32 and the corresponding search window selection mode is indicated by a variable, Fcode=1. For Fcode=2, 3, . . ., the search window sizes are 64×64, 128×128, . . ., respectively. Although the claimed subject matter is not limited to these block sizes, resolutions or particular search windows, nonetheless, employing them to perform calculations for a potential implementation is instructive. Hence, the computational burden involved for 720×480 resolution video at 30 frames per second is approximately.

42 Million SAD computations for 32×32 search window (Fcode=1)

168 Million SAD computations for 64×64 search window (Fcode=2)

Likewise, representative or sample bandwidth calculations may also be performed. A simplifying assumption is that individual processing elements (PE) in the motion estimation architecture do not have local storage within the PE, and, therefore, a PE is feed with pixel information for SAD computations. Data for an SAD computation is 512 Bytes in this embodiment—here, 256 bytes for a reference block and 256 for a matching block. Hence, the data bandwidth per second in this example is as follows.

For a 32×32 search window (Fcode=1)=42M*512 Bytes=21 GB

For a 64×64 search window (Fcode=2)=168M*512 Bytes=84 GB

An embodiment of a method for motion estimation employing a mesh-connected parallel processing architecture 100 is described. Such an embodiment provides advantages in terms of computational performance and/or bandwidth utilization, as described in more detail hereinafter.

Although the claimed subject matter is not limited in scope in this respect, in one embodiment, an image processing architecture may be contained on an integrated circuit (IC) chip designed to implement complex image processing using special purpose image signal processing (ISP) engines. In one embodiment, for example, as illustrated in FIG. 2, a two dimensional mesh coupled architecture 100 in which the ISPs employ common quad-ports may be utilized. Here, a quad-port is to provide a communication mechanism between ISPs 110. These channels are used to pass data/control information from one ISP to another. There are several typical or common approaches to couple processors together (e.g., star, ring, bus, etc.). Although the claimed subject matter is not limited in scope to employing a quad port, the quad port mechanism has at least two features making it desirable in this context: single hop connectivity to an adjacent processor, and ease of implementation. In this context, references to mesh and quad-ports are used interchangeable. The quad ports provide data transfer between adjacent ISPs and between ISPs and DDR in this embodiment. In this embodiment, physically, the quad ports may be implemented as two unidirectional buses (e.g., one in each direction), although, again, the claimed subject matter is not limited in scope in this respect.

For some applications, the computational burden to be applied may exceed the capability of one ISP or even two ISPs. In these cases, a capability to communicate between multiple ISPs is desirable. As illustrated in FIG. 2, for example, multiple ISPs may be mutually coupled using external interfaces to cascade multiple ISPs to perform a complex computational job.

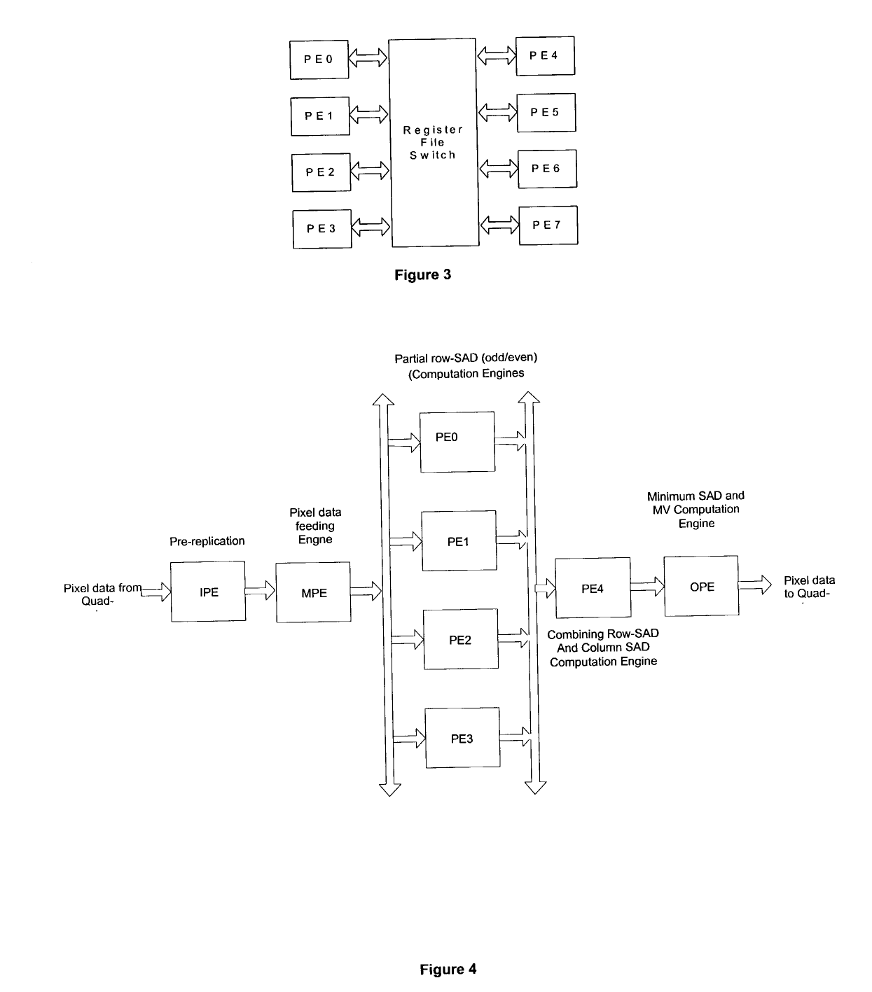

Although FIG. 2 illustrates a 9-ISP mesh coupled architecture, the claimed subject matter is not limited in scope in this respect. For example, an embodiment may comprise any two dimensional architecture in principle. Here, the ISPs themselves comprise several basic processing elements (PE) coupled together via a register file switch, as shown in FIG. 3.

Although the claimed subject matter is not limited in scope in this respect, in this particular embodiment, a register file 200 comprises a bank of 16 registers. In this embodiment, a register may be written to by any PE and may be read by any PE. Thus, a register may be used as a link to send data from one PE to another. A register has 8-write ports, so that, for this particular embodiment, any PE may write to it. Likewise, here a register has 1 read port that couples to all PEs. The register file in this embodiment also includes a stalling mechanism that stalls a PE attempting to write when (a) there is a higher priority PE that is also attempting to write in the same cycle and/or (b) the register has unread data. It is of course appreciated that alternate embodiments may omit a register file or may employ a register file with additional and/or different capabilities.

Using general-purpose registers (GPRS) in the register file switch, a PE may communicate with another PE in the ISP in this particular embodiment. Here, there are up to 16 GPRs in a register file switch allowing concurrent communication between various PEs at substantially the same time, if desired.

In this particular embodiment, a GPR may be written and read by any PE. Likewise, in this particular embodiment, PE may write to and read from any GPR. For example, PE0 may use GR0 to send data to PE1. At substantially the same time, PE2 may use GR2 to send data to PE4, etc. Thus, although the claimed subject matter is not limited in scope in this respect, there may be up to 16 concurrent transfers occurring on a given cycle.

In this embodiment, therefore, the register file switch provides a mechanism for sharing data between PEs. Although the claimed subject matter is not limited in scope in this respect, in this embodiment, a PE has a dual SAD computation capability by performing SAD computations in parallel. Furthermore, the quad-port structure in this embodiment comprises a point-to-point link with FIFOs to allow for or accommodate relatively quick variations in data generation/consumption rates. A SAD may be implemented in this embodiment using a special instruction, directed to the processing elements (PEs).

In this particular embodiment, as illustrated in FIG. 3, an ISP includes the register file switch to provide a non-blocking mechanism for PEs to mutually communicate. In this embodiment, the register file switch comprises a full N×N switch. A PE may use a register to direct data to one or more PEs. In this particular embodiment, the Data Valid (DV) bits in a register provide a technique of targeting register data to a specific PE or a number of PEs, although, of course, the claimed subject matter is not limited in scope in this respect.

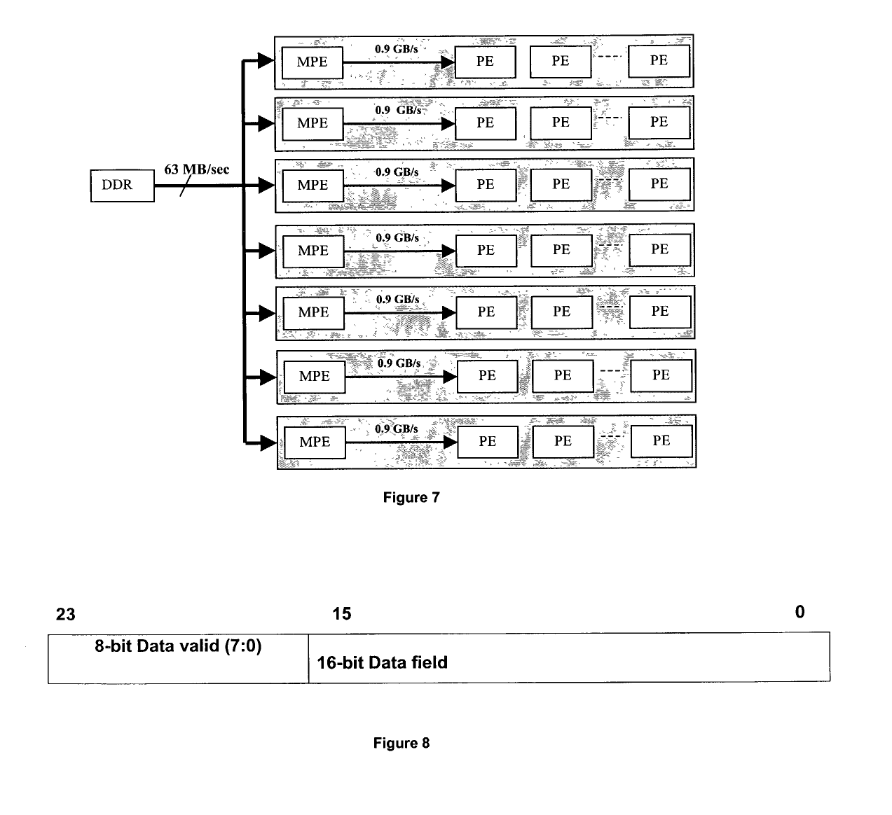

FIG. 8 is a schematic diagram illustrating an embodiment of a layout for a GPR. In this embodiment, a 16-bit data field holds the actual value of the data to be transferred from one PE to one or more other PEs. An 8-bit data field (DV7-DV0)field operates here similar to an address field. It indicates in this embodiment for which PE data is valid. If DV0 is ‘1’, then this data is intended for PE0. Similarly, if DV1=‘1’ then this data is intended for PE1. If all DVx's are 1, (DV0=1, DV1=1, . . . , DV7=1) then this data is intended for all the PEs (e.g., this mechanism provides unicast, multicast and broadcast functionality).

In this embodiment, the PEs within an ISP may be customized to perform specific functions. For example, an input PE (IPE) may be employed to move data from input quadport(s) to registers. Similarly, a memory PE (MPE) may provide local storage to the PEs. An output PE (OPE) may be employed to move processed data out to quad-port(s). A general-purpose PE (GPE) may provide general-purpose processing functionality. In this embodiment, then, although the claimed subject matter is not limited in scope in this respect, for example, an ISP may comprise: an IPE, an OPE, 1 or more MPEs and 1 or more GPEs. The configuration of the ISP may depend, at least in part, on the particular application, including the mapping approach used to map the computation process to the ISP, as described in more detail herein after.

Since the computational power and bandwidth desired may in some instances be relatively high, using a single high-performance processor or a DSP to perform motion estimation may not provide a practical solution. In this embodiment, instead, the FS process is, in essence, “mapped” to multiple ISPs to take advantage of the ISP engines described above. In this particular embodiment, although the claimed subject matter is not limited in scope in this regard, the data and computation flows within the ISP are distributed amongst the PE,s as shown in FIG. 4. The IPE, in this embodiment, for example, could be used to pre-process incoming data, such as replicating the data, rearranging data patterns, etc. The MPE may receive the reference block and the search window information from a quad-port through an IPE and may store the data in its local memory. In order to store the reference block and the search window information, about 1.5 KB of memory is desired, assuming a 32×32 search window:

(16×16)+(32×32)+(16×16)Bytes=˜1.5 KB

In order to mitigate potential bandwidth constraints, 4 PEs (e.g., PE0, PE1, PE2, PE3 in FIG. 4) are employed in parallel in this embodiment to execute the SAD computation. The 4 PEs are operated in such a way as to share data between them.

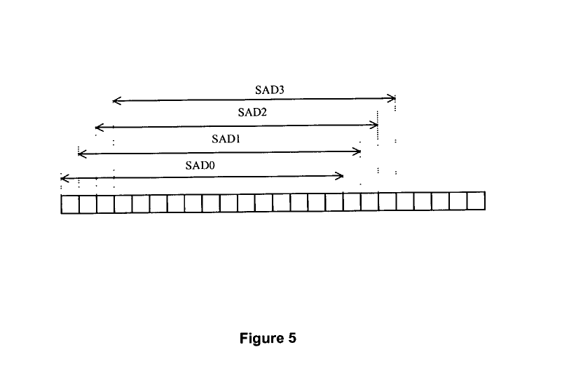

In order to illustrate the concept, consider the case where PE0, PE1, PE2 and PE3 run in parallel to compute an SAD for 4 consecutive positions in the search window. The MPE may store the reference macroblock and the search region and feed the 4 PEs with data in a proper sequence. In this embodiment, the reference macroblock may be fed to a PE using a set of 4 GPRs. The data from a search window in a previous frame may be fed to using a GPR. As an example, as illustrated in FIG. 5, four PEs may share pixel data in order to compute four SAD values in parallel.

Since the PEs are computing the SADs for consecutive positions, as alluded to above, pixel data may be shared in this particular embodiment, although the claimed subject matter is not limited in scope in this respect. In the example in FIG. 5, PE0 computes the SAD0 (for position 0), PE1 computes SAD 1 (for position 1) and so on. For a row of SAD computation, for example, PE0 and PE1 may share 15 pixels of the search region. Similarly, PE1 and PE2 may share 15 pixels of the search region, etc. Hence, in order to feed data to 4 PEs working in parallel, 16+3 or 19 pixels of data per row for 4 SAD computations may be employed for this embodiment, although, again, the claimed subject matter is not limited in scope to this example embodiment.

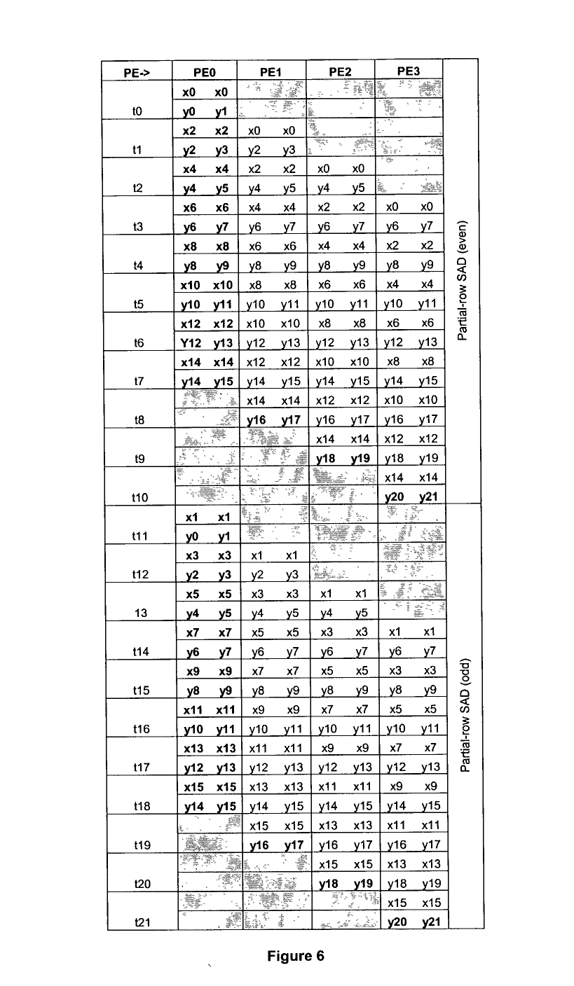

For the following discussion, reference is made to FIG. 6. The data flow of the macroblock and search window between MPE and 4 PEs in this particular embodiment is shown in FIG. 6. The data flow is developed in this embodiment using the assumption that an MPE may deliver 2 words in a cycle, although, again, the claimed subject matter is not limited in scope in this respect. The architecture for this particular embodiment is such that it is desirable to provide two words per cycle. The pipeline diagram of FIG. 6 illustrates 2 words per cycle will keep 4 PEs busy and also yield high throughput, as desired. Note that here, because in this embodiment a PE can compute 2 SADs in parallel, 8 consecutive SADs are computed in parallel. In this embodiment, 2 SADs/cycle are implemented in a PE utilizing 16 bit data paths. The GPRs and other data paths are 16-bit wide, allowing performance of 2 8-bit operations.

Another assumption for convenience and/or simplicity, although the claimed subject matter is not limited in scope in this respect, is that a reference block is stored in one block of memory and a search window is stored in another. Thus, two accesses (one for reference block data and another for search window data) are employed per cycle. In FIG. 6, new or additional data provided to a register in a given cycle is shown by bold face.

A parallel process to compute 8 SADs with such an architecture may be expressed in terms of pseudo-code as follows, although the subject matter is not limited in scope in this respect (let us assume that x0, x1, . . . , x15 are the pixels from a row of the reference block and y0, y1, y2, . . . are the corresponding data form the reference block to be matched):

Begin

IPE:

Input the macroblock (x) and the search region (y)
and replicate the pixels (x) into

2 copies;

MPE:

Store replicated x and also y into the local memory
and feed them to PE0, PE1,

PE2, PE3;

for row = 0 to 15 do (sequentially 16 rows are computed)
begin

/* PE0, PE1, PE2, PE3 executes the following
block in parallel */
/* The following tasks T1, T2 and T3 are executed in the
architecture in pipelined fashion */
T1: Par begin (PE₁)

/* Two SAD computations in parallel by the dual SAD

computation circuitry in PE */

Compute SADᵢ^{odd} (row) and SADᵢ^{even} (row)

Par end;

T2: PE4

Par: Aᵢ [symbol] Accumulate final SADᵢ^{odd} (row);

Bᵢ [symbol] Accumulate final SADᵢ^{even} (row);

T3: PE5:

SADᵢ [symbol] Aᵢ + Bᵢ;
Find minimum SAD and generate motion vector (MV);

End for:

End.

For this particular embodiment, the bandwidth capability desired may be recomputed as follows:

Bandwidth to compute 8 SAD=(16*4+6*2)*16 Bytes=1216 Bytes

Bandwidth to compute 42M SAD=1216*42 MB/8=6.4 GB/s

That represents an overall saving of >70% compared to 21 GB/s bandwidth, as computed earlier. The clock cycles to compute a 16×16 SAD may also be determined for this embodiment, e.g., having 4 PEs working in parallel. As discussed, in this example, a PE may compute 2 SADs in parallel, resulting in a potential doubling of the compute performance of the PE. Hence,

Clocks per PE per row of SAD computation=(22/2) clocks

(two SAD computations in parallel, from FIG. 6)

Clocks per PE per 16 rows of SAD computation=(11)*16 clocks

(for a 16×16 macroblock)

Clocks per ISP 16×16 SAD computation=(11*16)/4 clocks=44 clocks

(4 PEs operation in parallel)

Clocks per ISP for 42M SAD computation=44*42M clock=1848 M clocks

Assuming that ISPs run at 266 MHz, 7 ISPs therefore provide the capability to implement FS processing using a 32×32 search window (for a 64×64 search window, 28 ISPs may be employed).

Likewise, bandwidth capability may be determined as follows. An MPE may supply 2 words (16-bits each) per cycle (e.g., 4 bytes per cycle), providing a total bandwidth out of an MPE as 4*266 MB/s or ˜1.064 GB/s. By employing in this embodiment an MPE per ISP, total bandwidth capability exceeds 7.4 GB/s from 7 ISPs, higher than the desired bandwidth of 6.4 GB/s. Thus, as demonstrated, for this embodiment, 7 ISPs may suitably handle the data bandwidth for a 32×32 search window for block matching.

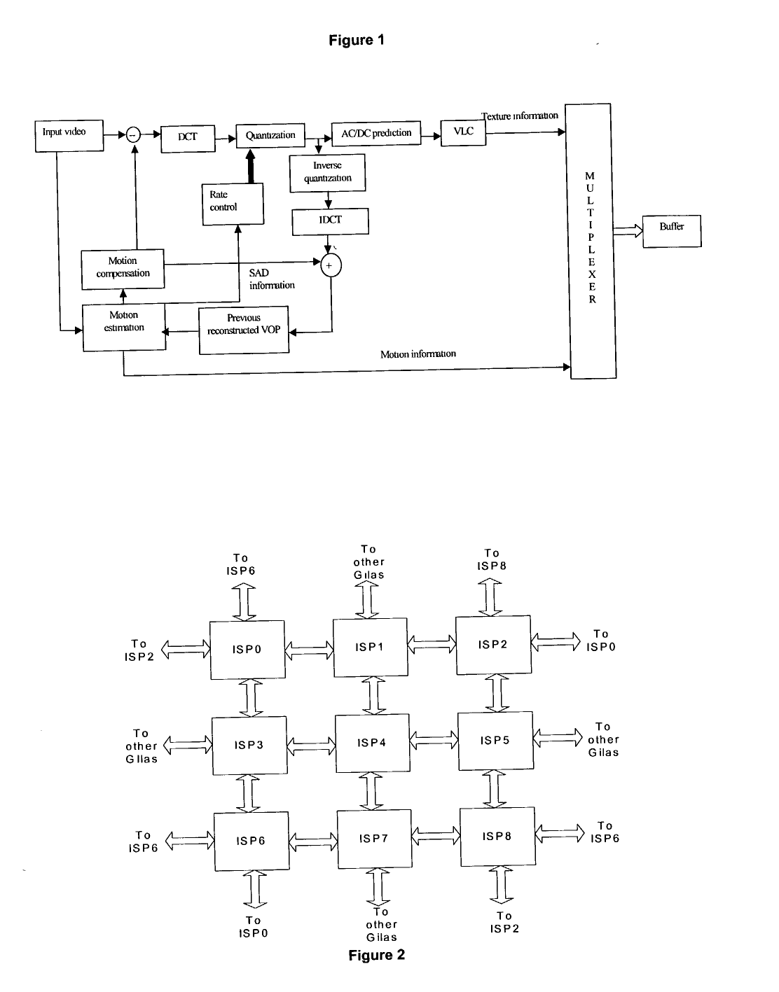

In the above discussion, synchronous DRAM (SDR) and/or dual-data rate DRAM (DDR) bandwidth to download the reference block and search region information to an MPE is now considered. The bandwidth (from FIG. 1) to download the current block and search window to an MPE is given by,

Bandwidth to download data for 1 macroblock=(16*16)+(32*32)+(16*16) Bytes

Bandwidth to download 1367 blocks=1367*1536 Bytes

Bandwidth desired per second=30*1367*1536 B/s=63 MB/s

Assuming one DDR channel (16-bit wide and running at 133 MHz), provides a total bandwidth of 2*133*2 MB/s or 512 MB/s, this is more than sufficient. The top level bandwidth estimation at different communication points for this embodiment is illustrated in FIG. 7.

It will, of course, be understood that, although particular embodiments have just been described, the claimed subject matter is not limited in scope to a particular embodiment or implementation. For example, one embodiment may be in hardware, such as implemented to operate on an integrated circuit chip, for example, whereas another embodiment may be in software. Likewise, an embodiment may be in firmware, or any combination of hardware, software, or firmware, for example. Likewise, although the claimed subject matter is not limited in scope in this respect, one embodiment may comprise an article, such as a storage medium. Such a storage medium, such as, for example, a CD-ROM, or a disk, may have stored thereon instructions, which when executed by a system, such as a computer system or platform, or an imaging or video system, for example, may result in an embodiment of a method in accordance with the claimed subject matter being executed, such as an embodiment of a method of performing motion estimation, for example, as previously described. For example, an image or video processing platform or another processing system may include a video or image processing unit, a video or image input/output device and/or memory.

While certain features of the claimed subject matter have been illustrated and described herein, many modifications, substitutions, changes and equivalents will now occur to those skilled in the art. It is, therefore, to be understood that the appended claims are intended to cover all such modifications and changes as fall within the true spirit of the claimed subject matter.

1. An integrated circuit comprising:
one or more image signal processing engines;
said one or more engines including a plurality of processing elements, said processing elements being mutually coupled by a register file switch;
said plurality of processing elements being further mutually coupled so that, during a block matching calculation, parallel processing and pixel data sharing is employed by said processing elements.

2. The integrated circuit of claim 1, wherein said integrated circuit has a configuration to perform a block matching calculation comprising a sum of absolute differences.

3. The integrated circuit of claim 2, wherein said integrated circuit has a configuration to perform a block matching calculation comprising a sum of absolute differences for a full search of a search window.

4. The integrated circuit of claim 1, wherein said image signal processing engine has a configuration so that at least four processing elements, during a block matching calculation, process pixel data in parallel.

5. The integrated circuit of claim 1, wherein said register file switch includes a plurality of registers coupled so that data is capable of being transferred between any two processing elements.

6. The integrated circuit of claim 1, wherein said integrated circuit includes a plurality of mutually coupled image signal processing engines;
said processing engines being mutually coupled to form a mesh configuration.

7. A system comprising:
a plurality of mutually coupled image signal processing engines;
said processing engines being mutually coupled to form a mesh configuration;
said processing engines including a plurality of processing elements, said processing elements being mutually coupled by a register file switch;
said plurality of processing elements being further mutually coupled so that, during a block matching calculation, parallel processing and pixel data sharing is employed by said processing elements.

8. The system of claim 7, wherein said system has a configuration to perform a block matching calculation comprising a sum of absolute differences.

9. The system of claim 8, wherein said system has a configuration to perform a block matching calculation comprising a sum of absolute differences for a full search of a search window.

10. The system of claim 7, wherein said image signal processing engine has a configuration so that at least four processing elements, during a block matching calculation, process pixel data in parallel.

11. The system of claim 7, wherein said register file switch includes a plurality of registers coupled so that data is capable of being transferred between any two processing elements.

12. The system of claim 7, wherein said system is embodied on a single integrated circuit chip.

13. The system of claim 7, wherein said system is contained within a video processing unit.

14. The system of claim 13, and further comprising a video input/output device.

15. A method of performing image block matching comprising:
during a block matching calculation, processing sequential search window pixel locations in parallel; and
sharing overlapping pixel data common to the sequential pixel locations.

16. The method of claim 15, wherein four or more sequential pixel locations are processed in parallel.

17. The method of claim 15, wherein the block matching calculation comprises the sum of absolute differences.

18. The method of claim 17, wherein the block matching calculation comprises the full search sum of absolute differences.
